(19) United States
(12) Patent Application Publication
(10) Pub. No.: US 2018/0236796 A1
(43) Pub. Date: Aug. 23, 2018

(54) INK-JET HEAD PROTECTION DEVICE

(71) Applicants: XYZPRINTING, INC., NEW TAIPEI CITY (TW); KINPO ELECTRONICS, INC., NEW TAIPEI CITY (TW)

(72) Inventor: Chia-Wu LIAO, NEW TAIPEI CITY (TW)

(21) Appl. No.: 15/603,456

(22) Filed: May 24, 2017

(30) Foreign Application Priority Data
Feb. 23, 2017 (CN) 201710100095.8

(51) Int. Cl. B41J 25/00; B41J 2/01

(52) U.S. Cl. CPC B41J 25/006; B41J 2/01

(57) ABSTRACT

An ink-jet head protection device used in a building area having accumulated powder is provided. The ink-jet head protection device includes a movable base and an airflow guiding mechanism. The movable base includes an ink-jet head base. The ink-jet head base includes one or more ink-jet heads. The ink-jet head is arranged corresponding to the building area. The airflow guiding mechanism is assembled to the movable base. The airflow guiding mechanism generates a dust separating airflow and includes an airflow opening for guiding the dust separating airflow flowing between the ink-jet head and the building area. The dust separating airflow is used to isolate the powder spilled from the building area. Accordingly, the airflow guiding mechanism generates the dust separating airflow flowing between the ink-jet head and the building area.

### TECHNICAL FIELD

The present invention relates to an ink-jet head protection device and, in particular, to an ink-jet head protection device for a printer.

### BACKGROUND

Three-dimensional (3D) printing refers to a process that evenly spreads a powdered material in a building area by a feeding mechanism, and dispenses a binder material to the powdered material by a nozzle mechanism, so that successive layers of the powdered material are joined to form a 3D object. At present, toys, mechanical parts or replacement human bones can be made by 3D printing, which makes 3D printing become an important rapid production technique.

However, 3D printing typically generates escaped or spilled powder which tends to clog and damage an ink-jet head. A lifespan of the ink-jet head can be greatly prolonged by preventing the ink-jet head from being contaminated by the escaped or spilled powder.

Accordingly, the target of the inventor is to solve the above-mentioned problems, on the basis of which the present invention is accomplished.

### SUMMARY

The present invention provides an ink-jet head protection device. The ink-jet head protection device uses an airflow guiding mechanism to generate a dust separating airflow flowing between an ink-jet head and the building area. The dust separating airflow is used to isolate powder spilled or escaped from the building area so as to prevent the ink-jet head from being contaminated by the spilled powder, thereby greatly prolonging a lifespan of the ink-jet head.

According to one embodiment of the present invention, the present invention provides an ink-jet head protection device, for use in a building area having accumulated powder. The ink-jet head protection device comprises: a movable base having an ink-jet head base, the ink-jet head base including at least one ink-jet head, the ink-jet head being disposed corresponding to the building area; and an airflow guiding mechanism, the airflow guiding mechanism being assembled to the movable base, the airflow guiding mechanism generating a dust separating airflow and including an airflow opening for guiding the dust separating airflow to flow between the ink-jet head and the building area, the dust separating airflow being used to isolate the powder spilled from the building area.

When a binder material dispensed in a printing direction from the ink-jet head drops in the building area and combines with a powdered material, it generates spilled powder which is light and can spread along the printing direction to be attached to the ink-jet head to cause clogging of the ink-jet head. Stability of the dust separating airflow decreases in a direction away from the airflow opening, so the dust separating airflow flows in a direction opposite and parallel to the printing direction, and the spilled powder is thereby away from the ink-jet head.

### BRIEF DESCRIPTION OF THE DRAWINGS

The disclosure will become more fully understood from the detailed description, and the drawings given herein below is for illustration only, and thus does not limit the disclosure, wherein:

FIG. 1 is a perspective assembled view illustrating an ink-jet head protection device according to the first embodiment of the present invention;

FIG. 2 is another perspective assembled view illustrating the ink-jet head protection device according to the first embodiment of the present invention;

FIG. 3 is a schematic in-use view illustrating the ink-jet head protection device according to the first embodiment of the present invention;

FIG. 4 is a perspective assembled view illustrating the ink-jet head protection device according to the second embodiment of the present invention;

FIG. 5 is a schematic in-use view illustrating the ink-jet head protection device according to the second embodiment of the present invention;

FIG. 6 is a perspective assembled view illustrating the ink-jet head protection device according to the third embodiment of the present invention; and

FIG. 7 is a schematic in-use view illustrating the ink-jet head protection device according to the third embodiment of the present invention.

### DETAILED DESCRIPTION

Detailed descriptions and technical contents of the present invention are illustrated below in conjunction with the accompany drawings. However, it is to be understood that the descriptions and the accompany drawings disclosed herein are merely illustrative and exemplary and not intended to limit the scope of the present invention.

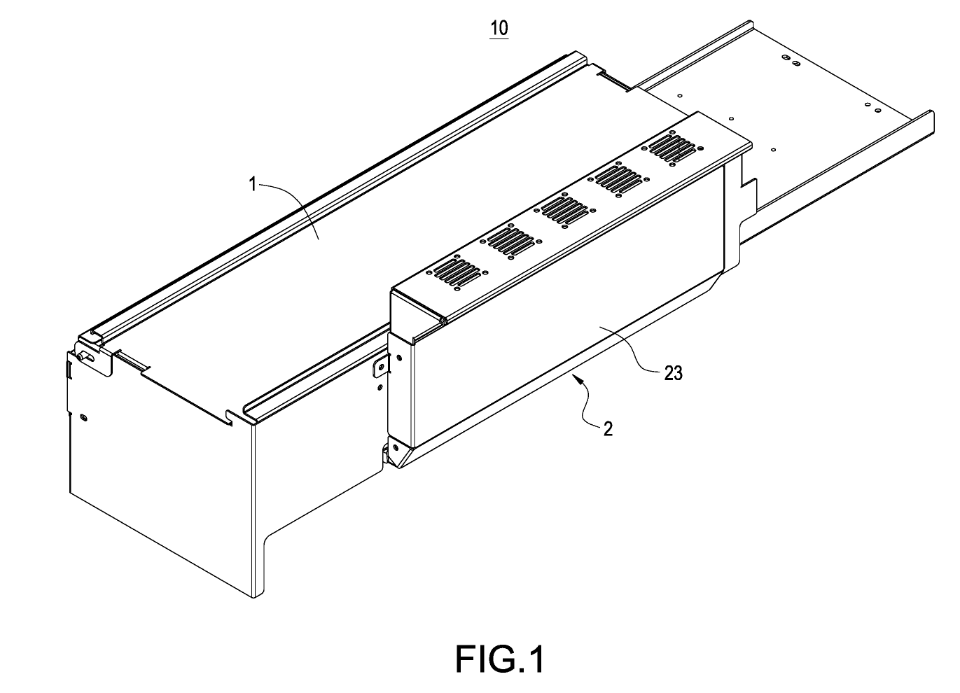

Please refer to FIGS. 1 to 3, showing an ink-jet head protection device according to the first embodiment of the present invention, for use in a building area 100 where a product is printed out. The building area 100 has accumulated powder. The ink-jet head protection device 10 includes a movable base 1 and an airflow guiding mechanism 2.

Referring to FIGS. 1 to 3, the movable base 1 defines a printing direction D and moves along the printing direction D. The movable base 1 includes an ink-jet head base 11; the ink-jet head base 11 includes one or multiple ink-jet heads 111, a left edge 112, and a right edge 113. The ink-jet head 111 is disposed corresponding to the building area 100.

Referring to FIGS. 1 to 3, the airflow guiding mechanism 2 is assembled to the movable base 1, the airflow guiding mechanism 2 generates a dust separating airflow A and includes an airflow opening 21 for guiding the dust separating airflow A flowing between the ink-jet head 111 and the building area 100, the dust separating airflow A flows in a direction opposite and parallel to the printing direction D, and the dust separating airflow A is used to isolate the powder escaped or spilled from the building area 100. The dust separating airflow A is a blowing-out airflow blown out of the airflow opening 21 from the transverse passage 22.

To be specific, the airflow guiding mechanism 2 includes a transverse passage 22 and a vertical passage 23, and the transverse passage 22 and the vertical passage 23 are fixed to the movable base 1. The transverse passage 22 is disposed at one side of the ink-jet head base 11, the transverse passage 22 forms the airflow opening 21 at one end close to the ink-jet head 111, and an inner surface of the transverse passage 22 includes an upper guiding face 221 and a lower guiding face 222 opposite to each other. The vertical passage 23 extends in an integral form from one end of the transverse passage 22 away from the ink-jet head 111 and communicates with the transverse passage 22. A left edge 112 and a right edge 113 of the ink-jet head base 11 are disposed at two sides of the airflow opening 21.

Furthermore, the upper guiding face 221 is an inclined surface 2211, the inclined surface 2211 inclines to the inside of the transverse passage 22 toward the ink-jet head 111, and the lower guiding face 222 is a horizontal surface 2221. The inclined surface 2211 and the horizontal surface 2221 form an included angle θ ranging from ten degrees to twelve degrees.

A fan 24 is installed in the vertical passage 23, the fan 24 is used to generate the dust separating airflow A; however, the present invention is not limited in this regard. The vertical passage 23 can also communicate with an external wind guiding pipe configured to guide the dust separating airflow A from the outside to the inside of the vertical passage 23.

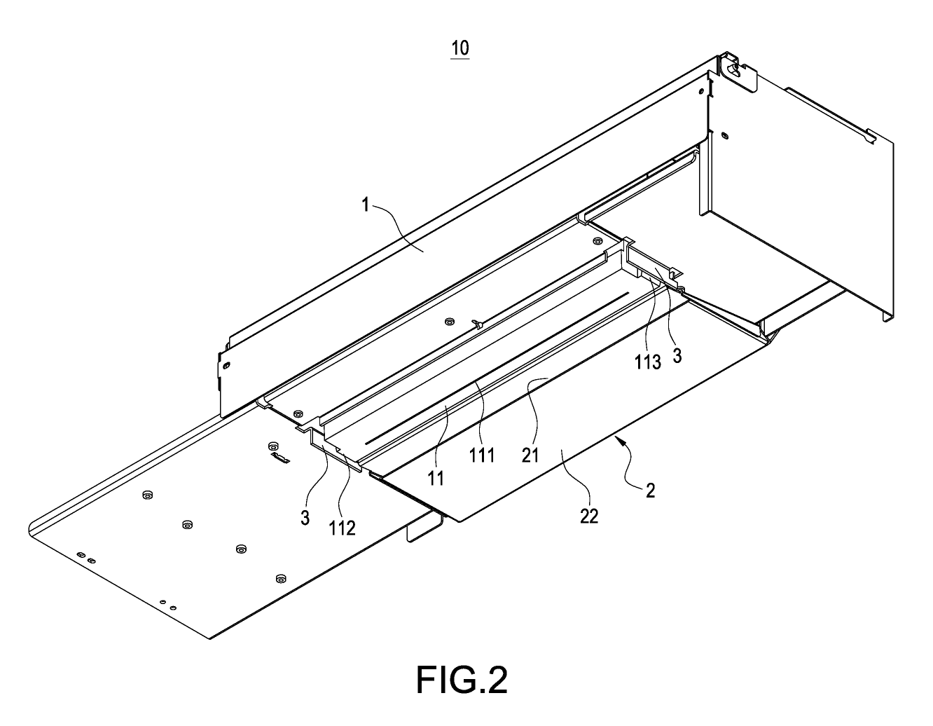

Referring to FIG. 2, the ink-jet head protection device 10 further includes two concentration boards 3. The two concentration boards 3 are fixed to the movable base 1 and are disposed at the left edge 112 and the right edge 13 of the ink-jet head base 11 respectively. The two concentration boards 3 are configured to prevent the dust separating airflow A flowing to the ink-jet head 111 from escaping to two sides. By adding the two concentration boards 3 at the two sides of the ink-jet head base 11 to prevent escape of the airflow, the ink-jet head protection device 10 can keep the dust separating airflow A stably flowing below the ink-jet head 111.

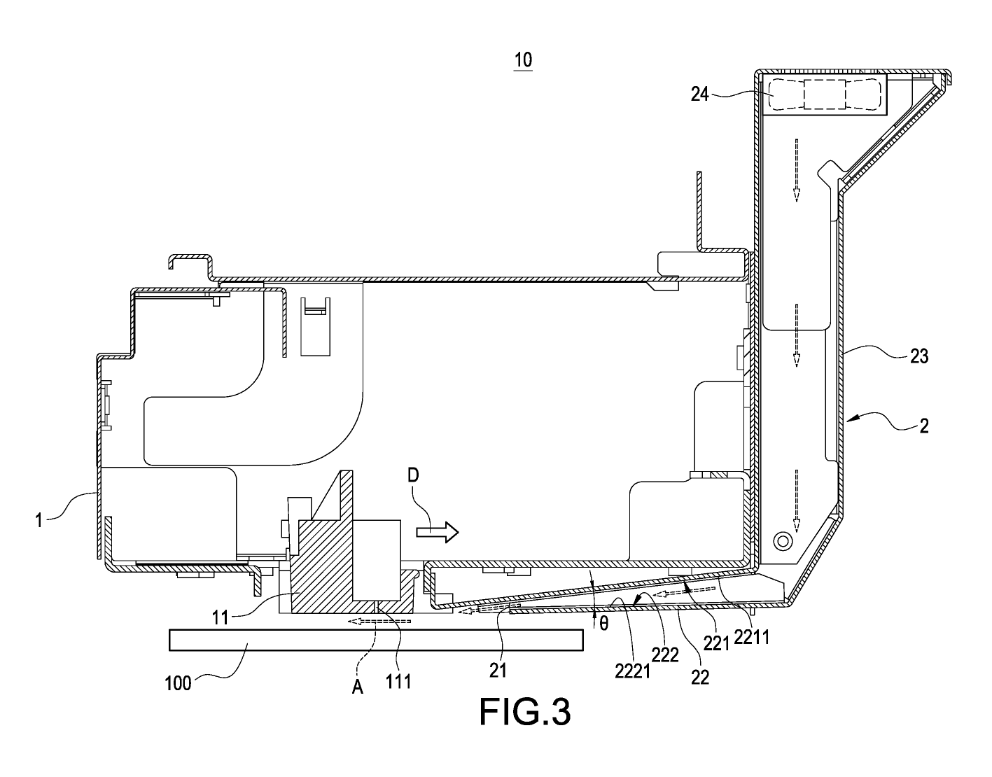

As shown in FIG. 3, according to the ink-jet head protection device 10 of the present invention, the movable base 1 includes an ink-jet head base 11. The ink-jet head base 11 includes at least one ink-jet head 111, and the ink-jet head 111 is disposed corresponding to the building area 100. The airflow guiding mechanism 2 is assembled to the movable base 1, the airflow guiding mechanism 2 generates a dust separating airflow A and includes an airflow opening 21 for guiding the dust separating airflow A to flow between the ink-jet head 111 and the building area 100, and the dust separating airflow A is used to isolate the powder spilled from the building area 100, thus preventing the ink-jet head 111 from being contaminated by the spilled or escaped powder, thereby greatly prolonging a lifespan of the ink-jet head 111.

Referring to FIG. 3 illustrating the ink-jet head protection device 10 in use, the ink-jet head 111 performs printing operations along the printing direction D. When a combination of a powdered material with a binder material dispensed from the ink-jet head 111 drops to the building area 100, it causes spilled powder. The ink-jet head 111 can be damaged when contaminated by spilled powder. In solution, the present invention uses the dust separating airflow A flowing between the ink-jet head 111 and the building area 100 to isolate the powder spilled from the building area 100, thus avoiding contamination of the ink-jet head 111 from the spilled powder, thereby protecting the ink-jet head 111.

Moreover, the dust separating airflow A flowing between the ink-jet head 111 and the building area 100 is formed by the following configuration. The fan 24 generates the dust separating airflow A blowing to the vertical passage 23. The vertical passage 23 guides the dust separating airflow A to flow downwardly to the transverse passage 22; the upper guiding face 221 is an inclined surface 2211 for guiding an upper portion of the dust separating airflow A to flow at an inclined angle. The lower guiding face 222 is a horizontal surface 2221 for guiding a lower portion of the dust separating airflow A to flow horizontally. The inclined surface 2211 and the horizontal surface 2221 form an included angle θ ranging from ten degrees to twelve degrees, so that the dust separating airflow A is maintained at a small slope and flows to between the ink-jet head 111 and the building area 100. The dust separating airflow A having the small slope can approach a position of the ink-jet head 111 well, thus further preventing the ink-jet head 111 from being contaminated by the spilled powder.

Furthermore, when the binder material dispensed from the ink-jet head 111 along the printing direction D drops in the building area 100 and combines with the powdered material, it generates spilled powder which is light and spreads along the printing direction D, and the ink-jet head 111 is clogged due to the spilled powder attached to it. Stability of the dust separating airflow A decreases in a direction away from the airflow opening 21, so the dust separating airflow A flows in a direction opposite and parallel to the printing direction D, and the spilled powder is thereby away from the ink-jet head 111.

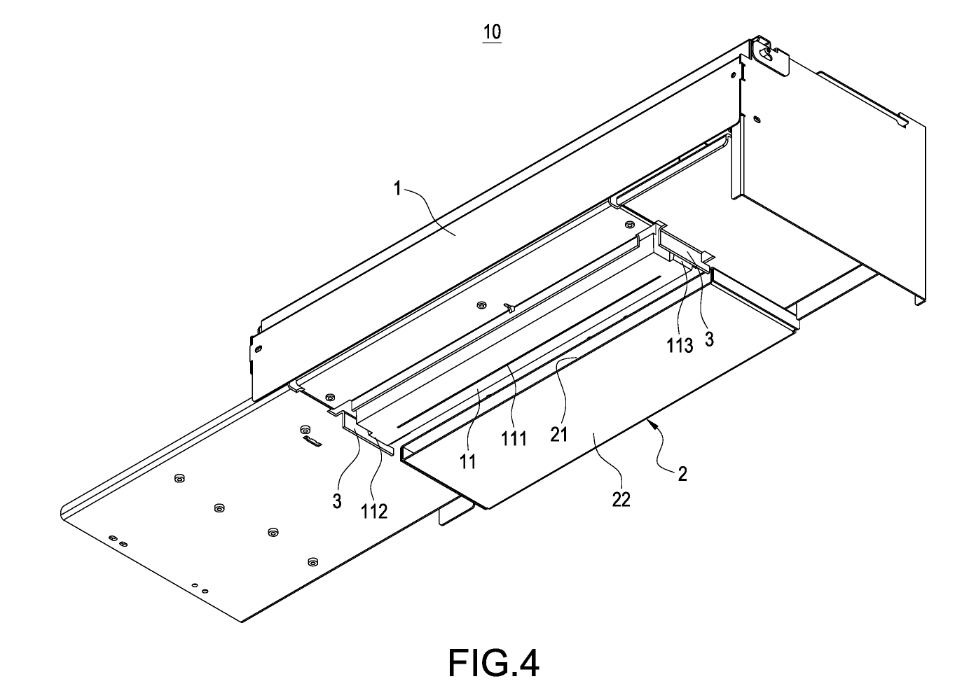

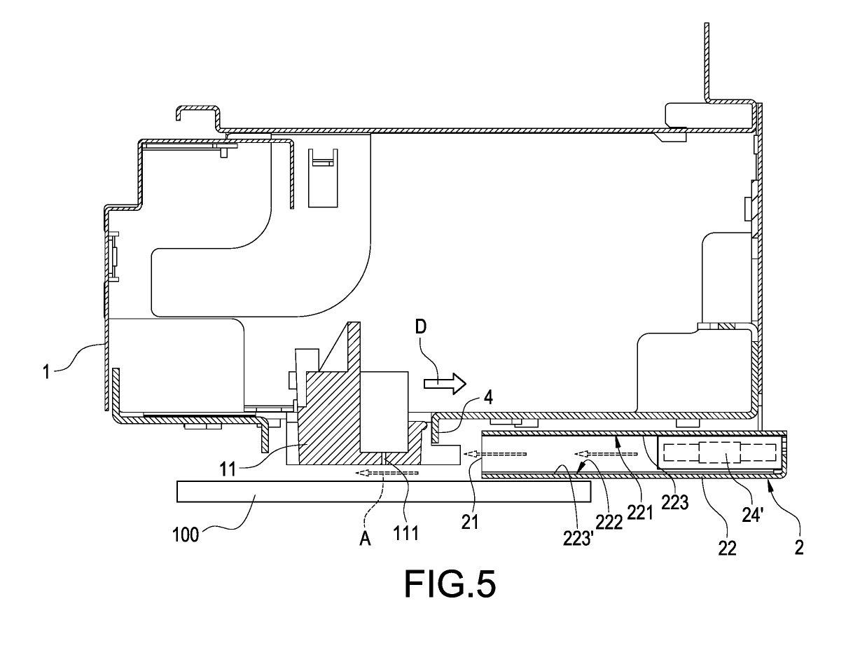

Please refer to FIGS. 4 and 5, showing the ink-jet head protection device 10 according to the second embodiment of the present invention. The second embodiment is similar to the first embodiment. The second embodiment is different from the first embodiment in that the upper guiding face 221 and the lower guiding face 222 are each a horizontal planar surface 223, 223′.

Moreover, the upper guiding face 221 is the horizontal planar surface 223 for guiding the upper portion of the dust separating airflow A to flow horizontally. The lower guiding face 222 is the horizontal planar surface 223′ to guide the lower portion of the dust separating airflow A to flow horizontally. The dust separating airflow A flowing out of the airflow opening 21 is maintained horizontal. Therefore, in order for the airflow opening 21 to successfully guide the dust separating airflow A to flow to between the ink-jet head 111 and the building area 100, a position of the lower guiding face 222 needs to protrude below the ink-jet head 111. Thus, the second embodiment can achieve the same functions and effects as the first embodiment.

Furthermore, the ink-jet head protection device 10 further includes a block plate 4, the block plate 4 is fixed to the movable base 1 and is disposed at one side of the ink-jet head base 11 adjacent to the airflow opening 21. The block plate 4 is configured to block the dust separating airflow A to thereby prevent the dust separating airflow A from directly flowing to the ink-jet head 111 and maintain the dust separating airflow A to flow below the ink-jet head 111.

Furthermore, a fan 24′ generating the dust separating airflow A is installed in the transverse passage 22. The fan 24′ generates the dust separating airflow A flowing to the transverse passage 22, and then the dust separating airflow A flows to below the ink-jet head 111 via the airflow opening 21.

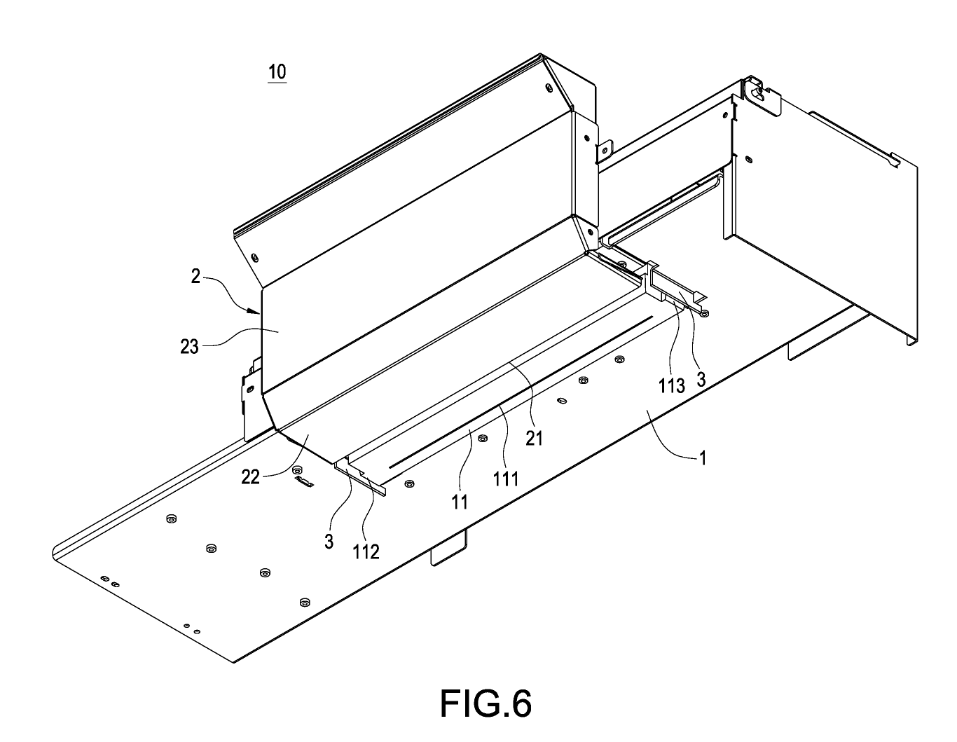

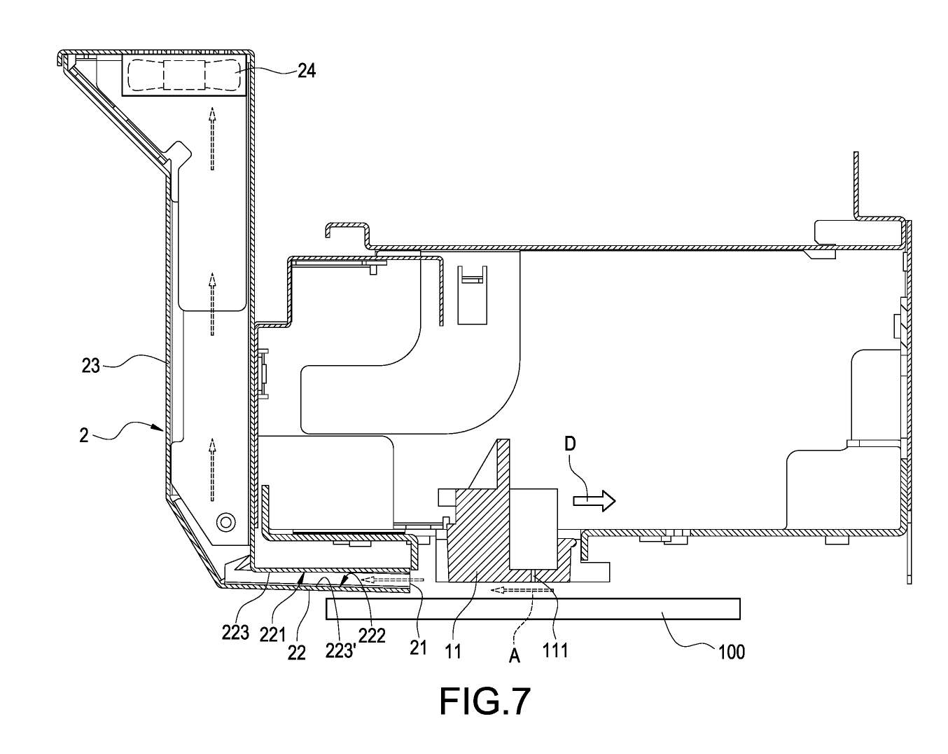

Please refer to FIGS. 6 and 7, showing the ink-jet head protection device 10 according to the third embodiment of the present invention. The third embodiment is similar to the second embodiment. The third embodiment is different from the second embodiment in that the dust separating airflow A is a sucking-in airflow taken into the transverse passage 22 from the airflow opening 21.

To be specific, the fan 24 generates the dust separating airflow A sucking into the vertical passage 23, so that the dust separating airflow A flows sequentially from the outside, through the airflow opening 21, through the transverse passage 22 and to the inside of the vertical passage 23. The upper guiding face 221 is the horizontal planar surface 223 for guiding the upper portion of the dust separating airflow A to flow horizontally, and the lower guiding face 222 is the horizontal planar surface 223′ for guiding the lower portion of the dust separating airflow A to flow horizontally. Therefore, in order for the airflow opening 21 to successfully suck out the dust separating airflow A between the ink-jet head 111 and the building area 100, the position of the lower guiding face 222 needs to protrude below the ink-jet head 111, so that the spilled powder in the building area 100 can be taken into the dust separating airflow A and flow along with the dust separating airflow A to be sucked into the inside of the transverse passage 22, thus preventing the spilled powder from contacting and contaminating the ink-jet head 111, thereby protecting the ink-jet head 111.

Moreover, the ink-jet head protection device 10 further includes a block plate 4′. The block plate 4′ is fixed to the movable base 1 and is disposed at one side of the ink-jet head base 11 away from the airflow opening 21. The block plate 4′ is adapted to block the dust separating airflow A to thereby prevent the dust separating airflow A from directly flowing to the ink-jet head 111 and maintain the dust separating airflow A to flow around the ink-jet head 111.

In summary, the ink-jet head protection device is neither disclosed by similar products nor used in public. The present invention also has industrial applicability, novelty and non-obviousness, so the present invention completely complies with the requirements of patentability. Therefore, a request to patent the present invention is filed pursuant to patent law. Examination is kindly requested, and allowance of the present application is solicited to protect the rights of the inventor.

What is claimed is:

1. An ink-jet head protection device, for a building area (100) having accumulated powder, the ink-jet head protection device comprising:
a movable base including an ink-jet head base, the ink-jet head base including at least one ink-jet head, the ink-jet head being disposed corresponding to the building area; and
an airflow guiding mechanism, the airflow guiding mechanism being assembled to the movable base, the airflow guiding mechanism generating a dust separating airflow and including an airflow opening for guiding the dust separating airflow to flow between the ink-jet head and the building area, the dust separating airflow being used to isolate the powder spilled from the building area.

2. The ink-jet head protection device of claim 1, wherein the movable base defines a printing direction and moves along the printing direction, and the dust separating airflow flows in a direction opposite and parallel to the printing direction.

3. The ink-jet head protection device of claim 2, wherein the airflow guiding mechanism includes a transverse passage, the transverse passage is fixed to the movable base and is disposed at one side of the ink-jet head base, the transverse passage forms the airflow opening at one end close to the ink-jet head, and an inner surface of the transverse passage includes an upper guiding face and a lower guiding face opposite to each other.

4. The ink-jet head protection device of claim 3, wherein the upper guiding face is an inclined surface, the inclined surface inclines to the inside of the transverse passage toward the ink-jet head, and the lower guiding face is a horizontal surface.

5. The ink-jet head protection device of claim 4, wherein the inclined surface and the horizontal surface form an included angle ranging from ten degrees to twelve degrees.

6. The ink-jet head protection device of claim 3, wherein the upper guiding face and the lower guiding face are each a horizontal planar surface, and a position of the lower guiding face protrudes below the ink-jet head.

7. The ink-jet head protection device of claim 3, wherein the dust separating airflow is a blowing-out airflow blown out of the airflow opening from the transverse passage.

8. The ink-jet head protection device of claim 7, further comprising a block plate, the block plate being fixed to the movable base and disposed at one side of the ink-jet head base adjacent to the airflow opening.

9. The ink-jet head protection device of claim 6, wherein the dust separating airflow is a sucking-in airflow taken into the transverse passage from the airflow opening.

10. The ink-jet head protection device of claim 9, further comprising a block plate, the block plate being fixed to the movable base and disposed at one side of the ink-jet head base away from the airflow opening.

11. The ink-jet head protection device of claim 2, further comprising two concentration boards, the ink-jet head base including a left edge and a right edge disposed at two sides of the airflow opening respectively, the two concentration boards being fixed to the movable base and disposed at the left edge and the right edge.

12. The ink-jet head protection device of claim 3, wherein the airflow guiding mechanism further includes a vertical passage, the vertical passage is fixed to the movable base, the vertical passage extends in an integral form from one end of the transverse passage away from the ink-jet head and communicates with the transverse passage, and a fan generating the dust separating airflow is installed in the vertical passage.

13. The ink-jet head protection device of claim 3, wherein a fan generating the dust separating airflow is installed in the transverse passage.
